(19) United States
(12) Patent Application Publication
(10) Pub. No.: US 2022/0261754 A1
(43) Pub. Date: Aug. 18, 2022

(54) INFORMATION PROCESSING APPARATUS, INFORMATION PROCESSING METHOD, AND NON-TRANSITORY STORAGE MEDIUM

(71) Applicant: TOYOTA JIDOSHA KABUSHIKI KAISHA, Toyota-shi Aichi-ken (JP)

(72) Inventor: Shintaro Matsutani, Toyota-shi Aichi-ken (JP)

(21) Appl. No.: 17/672,128

(22) Filed: Feb. 15, 2022

(30) Foreign Application Priority Data
Feb. 18, 2021 (JP) 2021-024128

(51) Int. Cl. G06Q 10/08; G06Q 30/06

(52) U.S. Cl. CPC G06Q 10/0875; G06Q 30/0635

(57) ABSTRACT

The present disclosure is intended to accurately manage a stock quantity of a specific product held by a user. A controller comprising at least one processor in an information processing apparatus obtains an estimated value of the stock quantity of the specific product at a timing when an order for the specific product held by the user is received from the user. Then, in cases where the estimated value thus obtained is equal to or greater than a predetermined threshold value at which the user is assumed to place an order for the specific product, the controller in the information processing apparatus performs processing for checking a current stock quantity of the specific product.

### CROSS REFERENCE TO THE RELATED APPLICATION

This application claims the benefit of Japanese Patent Application No. 2021-024128, filed on Feb. 18, 2021, which is hereby incorporated by reference herein in its entirety.

### BACKGROUND

### Technical Field

The present disclosure relates to an information processing apparatus, an information processing method, and a non-transitory storage medium.

### Description of the Related Art

Patent literature 1 discloses a store information processing apparatus. The store information processing apparatus disclosed in Patent Literature 1 predicts a next purchase date of a product in a specific category of a customer from a purchase cycle of the product in the specific category calculated from a purchase history. Then, the store information processing apparatus notifies the customer of information to encourage the purchase of the product in the specific category when the next purchase date is coming.

### CITATION LIST

### Patent Literature

Patent Literature 1: Japanese Patent Application Laid-Open Publication No. 2003-132258

### SUMMARY

An object of the present disclosure is to accurately manage a stock quantity of a specific product held by a user.

An information processing apparatus according to a first aspect of the present disclosure includes a controller comprising at least one processor configured to perform:

obtaining an estimated value of a stock quantity of a specific product at a timing when an order for the specific product held by a user is received from the user; and

executing processing for checking a current stock quantity of the specific product, when the estimated value thus obtained is equal to or greater than a predetermined threshold value at which the user is assumed to place an order for the specific product.

An information processing method according to a second aspect of the present disclosure is an information processing method that is performed by a computer and comprises:

obtaining an estimated value of a stock quantity of a specific product at a timing when an order for the specific product held by a user is received from the user; and

executing processing for checking a current stock quantity of the specific product, when the estimated value thus obtained is equal to or greater than a predetermined threshold value at which the user is assumed to place an order for the specific product.

A non-transitory storage medium according to a third aspect of the present disclosure is a non-transitory storage medium storing a program causing a computer to perform an information processing method that comprises:

obtaining an estimated value of a stock quantity of a specific product at a timing when an order for the specific product held by a user is received from the user; and

executing processing for checking a current stock quantity of the specific product, when the estimated value thus obtained is equal to or greater than a predetermined threshold value at which the user is assumed to place an order for the specific product.

According to the present disclosure, it is possible to accurately manage a stock quantity of a specific product held by a user.

### BRIEF DESCRIPTION OF THE DRAWINGS

FIG. 1 is a view illustrating a schematic configuration of a management system according to a first embodiment;

FIG. 2 is a block diagram schematically illustrating an example of a functional configuration of a management server according to the first embodiment;

FIG. 3 is a diagram showing an example of a table configuration of stock information stored in a stock database;

FIG. 4 is a flowchart of check processing;

FIG. 5 is a view illustrating a schematic configuration of a management system according to a second embodiment;

FIG. 6 is a block diagram schematically illustrating an example of a functional configuration of a management server according to the second embodiment;

FIG. 7 is a diagram illustrating an example of a table configuration of history information stored in a history database; and

FIG. 8 is a flowchart of estimation processing.

### DESCRIPTION OF THE EMBODIMENTS

An information processing apparatus according to a first aspect of the present disclosure is an information processing apparatus that manages a stock quantity of a specific product held by a user. The information processing apparatus manages the stock quantity of the specific product based on an estimated value of the stock quantity of the specific product (hereinafter, may be simply referred to as an “estimated value”). Here, the estimated value is, for example, a value based on a detection value related to the stock quantity of the specific product detected by a sensor that senses the specific product. In addition, the estimated value is, for example, a value based on the stock quantity of the specific product estimated based on an order history of the specific product by the user.

At this time, the estimated value may be different from an actual stock quantity of the specific product held by the user. In this case, it is assumed that the actual stock quantity of the specific product will be less than the estimated value. Then, it is assumed that the user will place an order for the specific product due to the low actual stock quantity of the specific product, even though the stock quantity of the specific product is sufficient in the estimated value. By receiving the order for the specific product from the user, the information processing apparatus can grasp that the actual stock quantity of the specific product is getting low.

Therefore, a controller comprising at least one processor in the information processing apparatus obtains the estimated value at a timing when the order for the specific product is received from the user. Then, when the estimated value thus obtained is equal to or greater than a predetermined threshold value, the controller in the information processing apparatus performs processing for checking the current stock quantity of the specific product. Here, the processing for checking the current stock quantity of the specific product is, for example, to instruct a sensor, which detects a detection value related to the stock quantity of the specific product, to check the current stock quantity of the specific product. The processing for checking the current stock quantity of the specific product is, for example, to request the user to notify the current stock quantity of the specific product. Here, the predetermined threshold value is a stock quantity of the specific product at which the user is assumed to place an order for the specific product.

As described above, there may be an error in the estimated value. For this reason, the user may place an order for the specific product because the actual stock quantity of the specific product is low, even though the stock quantity (estimated value) of the specific product managed by the information processing apparatus is sufficient. In this case, the information processing apparatus performs processing for checking the current stock quantity of the specific product. Accordingly, the information processing apparatus can obtain the current stock quantity of the specific product that has been checked by the sensor or notified by the user. This prevents the information processing apparatus from managing the stock quantity of the specific product based on a wrong or incorrect estimated value. As a result, it is possible to accurately manage the stock quantity of the specific product held by the user.

Hereinafter, specific embodiments of the present disclosure will be described based on the accompanying drawings. The dimensions, materials, shapes, relative arrangements, and the like of the components described in the embodiments are not intended to limit the technical scope of the present disclosure only to them unless otherwise specified.

### First Embodiment

(Overview of System)

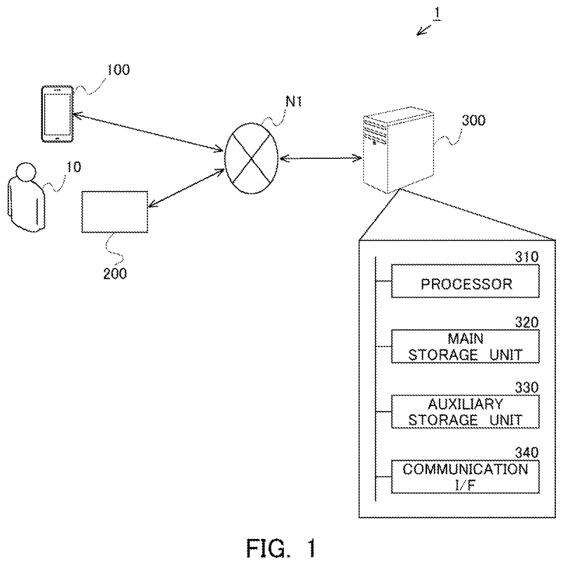

A management system 1 in a first embodiment will be described based on FIG. 1. FIG. 1 is a view illustrating a schematic configuration of the management system 1 in the first embodiment. The management system 1 is configured to include a user terminal 100, a sensor 200, and a management server 300. In the management system 1, the user terminal 100, the sensor 200, and the management server 300 are connected to one another via a network N1. For example, WAN (Wide Area Network), which is a worldwide public communication network such as the Internet, or a telephone communication network such as a cellular phone network may be adopted as the network N1.

(Sensor)

The sensor 200 is a sensor that senses a specific product held by a user 10 and detects a stock quantity of the specific product. The sensor 200 is installed, for example, at the home of the user 10 and detects the stock quantity of the specific product existing in the home of the user 10. In addition, in the present embodiment, the sensor 200 is a weight sensor that detects the weight of the specific product as a detection value. In this case, the sensor 200 transmits the weight of the specific product as the stock quantity of the specific product to the management server 300 via the network N1. Note that the specific product may be a product existing in a predetermined place, and may not necessarily be a product existing in the home of the user 10. The specific product may be, for example, a product existing in the workplace of the user 10.

(Management Server)

The management server 300 is a server device that manages the stock quantity of the specific product held by the user 10 (hereinafter, may be simply referred to as the “specific product”). In addition, the management server 300 is also a server device that receives an order for a specific product from the user

The management server 300 manages the stock quantity of the specific product based on the weight of the specific product (hereinafter, may be referred to as a “first stock quantity”) received from the sensor 200. That is, the management server 300 uses the weight of the specific product received from the sensor 200 as an estimated value of the stock quantity of the specific product, and manages the stock quantity of the specific product based on the estimated value.

When the first stock quantity becomes smaller than a predetermined threshold value, the management server 300 notifies the user 10 of a proposal to order the specific product. Specifically, the management server 300 transmits, via the network N1, information proposing an order of the specific product to the user 10 (hereinafter, may be referred to as “proposal information”) to the user terminal 100. Here, the predetermined threshold value is a stock quantity of the specific product at which the user 10 is assumed to place an order for the specific product.

Here, for example, it is assumed that a sensing error may occur in the sensor 200, causing the sensor 200 to detect a wrong or incorrect weight. In addition, for example, it is also assumed that an incorrect weight is detected by the sensor 200 that detects a weight other than that of the specific product. Accordingly, it is assumed that the first stock quantity grasped by the management server 300 is different from an actual stock quantity (hereinafter, may be referred to as a “second stock quantity”) of the specific product held by the user 10. That is, it is assumed that the stock quantity (first stock quantity) of the specific product estimated by the management server 300 to be held by the user 10 is different from the second stock quantity. In this case, it is assumed that the user 10 will place an order for the specific product because the second stock quantity has become small, even though the first stock quantity is sufficient.

Therefore, when receiving an order for the specific product from the user 10 even though the first stock quantity is sufficient, the management server 300 instructs the sensor 200 to check the current stock quantity of the specific product. Then, the sensor 200 will detect the weight of the specific product again. In this manner, by detecting the weight of the specific product at a timing different from the timing at which the sensor 200 detects the wrong weight of the specific product, it is possible to prevent the sensor 200 from detecting the wrong weight of the specific product. The first stock quantity in the present embodiment corresponds to an “estimated value of a stock quantity of a specific product” according to the present disclosure.

The management server 300 is configured to include a computer having a processor 310, a main storage unit 320, an auxiliary storage unit 330, and a communication interface (communication I/F) 340. The processor 310 is, for example, a CPU (Central Processing Unit) or a DSP (Digital Signal Processor). The main storage unit 320 is, for example, a RAM (Random Access Memory). The auxiliary storage unit 330 is, for example, a ROM (Read Only Memory). Also, the auxiliary storage unit 330 is, for example, an HDD (Hard Disk Drive) or a disk recording medium such as a CD-ROM, a DVD disk, or a Blu-ray disk. In addition, the auxiliary storage unit 330 may be a removable medium (portable storage medium). Here, a USB memory or an SD card is exemplified as the removable media. The communication I/F 340 is, for example, a LAN (local area network) interface board or a wireless communication circuit for wireless communication.

In the management server 300, the auxiliary storage unit 330 stores an operating system (OS), various programs, various information tables, and the like. In addition, in the management server 300, the processor 310 loads a program stored in the auxiliary storage unit 330 into the main storage unit 320 and executes the program, thereby making it possible to realize a variety of kinds of functions as described later. However, some or all of the functions of the management server 300 may be realized by a hardware circuit such as an ASIC or an FPGA. Here, note that the management server 300 does not necessarily need to be realized by a single physical configuration, but may be composed of a plurality of computers that work together. Also, note that the sensor 200 is configured to include a computer, similar to the management server 300. Further, the management server 300 in the present embodiment corresponds to an “information processing apparatus” according to the present disclosure.

(User Terminal)

The user terminal 100 is a terminal associated with the user 10. The user terminal 100 is a computer, a portable information terminal, or the like used by the user 10. When the second stock quantity becomes small, the user 10 uses the user terminal 100 to place an order for the specific product. In addition, when receiving the proposal information from the management server 300, the user terminal 100 displays an indication that a proposal is made to place an order for the specific product. This prompts the user 10 to place an order for the specific product, and the user 10 places the order for the specific product. When the user 10 orders the specific product by using the user terminal 100, the user terminal 100 transmits information for ordering the specific product (hereinafter, may be referred to as “order information”) to the management server 300 via the network N1. The management server 300 receives the order information from the user 10, thereby accepting the order of the specific product from the user 10.

(Functional Configuration)

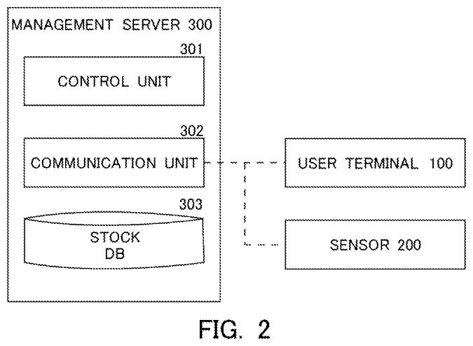

Next, a functional configuration of the management server 300 constituting the management system 1 in the present embodiment will be described based on FIG. 2. FIG. 2 is a block diagram schematically illustrating an example of the functional configuration of the management server 300 in the present embodiment.

The management server 300 is configured to include a control unit 301, a communication unit 302, and a stock or inventory database 303 (hereinafter, a stock DB 303). The control unit 301 has a function of performing arithmetic processing for controlling the management server 300. The control unit 301 can be realized by the processor 310 in the management server 300. The communication unit 302 has a function of connecting the management server 300 to the network N1. The communication unit 302 can be realized by the communication I/F 340 in the management server 300.

The stock DB 303 is a database for storing stock information related to the stock of the specific product. The stock DB 303 can be realized by the auxiliary storage unit 330 in the management server 300. The control unit 301 repeatedly receives the weight of the specific product from the sensor 200 at regular intervals by the communication unit 302. The control unit 301 generates stock information based on the weight of the specific product and stores the stock information in the stock DB 303. At this time, if the stock information has already been stored in the stock DB 303, the existing stock information is replaced with the newly generated stock information.

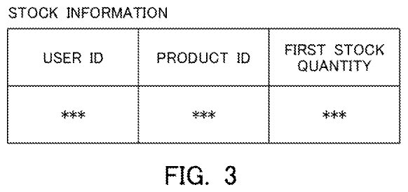

FIG. 3 is a diagram illustrating an example of a table configuration of the stock information stored in the stock DB 303. As illustrated in FIG. 3, the stock information includes a user ID field, a product ID field, and a first stock quantity field. In the user ID field, an identifier (user ID) for identifying the user 10 is entered. In the product ID field, an identifier (product ID) for identifying a product is entered. Here, in the product ID field, a product ID corresponding to the specific product is entered. In the first stock quantity field, the weight of the specific product received from the sensor 200 is entered as the first stock quantity.

The control unit 301 receives the order information via the communication unit 302. Upon receiving the order information, the control unit 301 obtains the first stock quantity from the stock DB 303. Then, the control unit 301 performs predetermined determination processing. The predetermined determination processing is processing of determining whether or not the first stock quantity is equal to or greater than the predetermined threshold value. When an affirmative determination is made in the predetermined determination processing, the control unit 301 can grasp that there is an error in the stock information stored in the stock DB 303, and that the second stock quantity is small even though the first stock quantity is sufficient. Accordingly, in the information processing apparatus, when an affirmative determination is made in the predetermined determination processing, the control unit 301 transmits information for instructing to check the current stock quantity of the specific product (hereinafter, may be referred to as “instruction information”) to the sensor 200 via the communication unit 302.

(Check Processing)

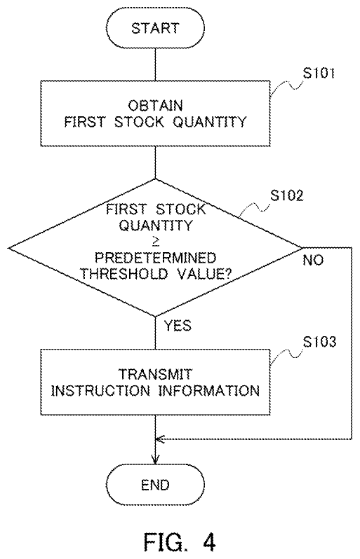

Next, in the management system 1 according to the present embodiment, the check processing to be performed by the control unit 301 in the management server 300 will be explained based on FIG. 4. FIG. 4 is a flowchart of check processing. The check processing is processing for determining whether or not there is an error in the first stock quantity, and for performing processing for checking the current stock quantity of the specific product when there is an error in the first stock quantity. The check processing is performed when the management server 300 receives the order information from the sensor 200. That is, when the order for the specific product is received from the user 10, the control unit 301 starts execution of the check processing.

In the check processing, first, in S101, the first stock quantity is obtained from stock information stored in the stock DB 303. Then, in S102, the predetermined determination processing is performed. That is, it is determined whether or not the first stock quantity is equal to or greater than the predetermined threshold value. When a negative determination is made in S102, the first stock quantity is less than the predetermined threshold value. That is, the first stock quantity and the second stock quantity are both stock quantities at which the user 10 is expected to order the specific product. Therefore, the check processing is ended.

In addition, when an affirmative determination is made in S102, the control unit 301 can grasp that there is an error in the first stock quantity. Accordingly, in S103, instruction information is transmitted to the sensor 200 in order to check the current stock quantity of the specific product. Then, the check processing is ended.

Upon receiving the instruction information from the management server 300, the sensor 200 detects the weight of the specific product and transmits the weight thus detected to the management server 300. Then, the management server 300 generates stock information based on the weight of the specific product newly detected by the sensor 200, and stores it in the stock DB 303. That is, the management server 300 updates the incorrect stock quantity (weight) of the specific product in the stock information to the weight of the specific product newly detected by the sensor 200.

As described above, when an affirmative determination is made in the predetermined determination processing, the instruction information is transmitted to the sensor 200. Accordingly, when there is an error in the first stock quantity, the management server 300 can receive from the sensor 200 the weight of the specific product newly detected by the sensor 200. Thus, the management server 300 can correct the stock information based on the weight of the specific product newly detected by the sensor 200. This prevents the management server 300 from managing the stock quantity of the specific product based on the incorrect stock quantity of the specific product. As a result, it will be possible to accurately manage the stock quantity of the specific product.

(Modification)

Here, note that in the present embodiment, the sensor 200 is the weight sensor that detects the weight of the specific product. However, the sensor 200 may not necessarily be a weight sensor as long as it is a sensor that senses the specific product to detect a detection value related to the stock quantity of the specific product. The sensor 200 may be, for example, a sensor that reads a non-contact IC chip of each piece of the specific product. In this case, the sensor 200 can be realized by an RFID (Radio Frequency Identifier) reader that reads an RF (Radio Frequency) tag provided on each piece of the specific product. The sensor 200 detects the number of pieces of the specific product by reading the RF tag of each piece of the specific product. Then, the sensor 200 transmits the number of pieces of the specific product to the management server 300 as the stock quantity of the specific product.

In addition, in the check processing in the present embodiment, the management server 300 transmits instruction information to the sensor 200 when an affirmative determination is made in the predetermined determination processing. However, when a predetermined determination is made in the check processing, the management server 300 may not necessarily transmit the instruction information to the sensor 200. The management server 300 may transmit request information to the user terminal 100, instead of transmitting instruction information to the sensor 200. Here, the request information is information for requesting the user to notify the stock quantity of the specific product. In this case, the user terminal 100, which has received the request information, performs a display for requesting the user 10 to notify the current stock quantity of the specific product. With this display, the user 10 is prompted to notify the management server 300 of the current stock quantity of the specific product. The user 10 enters the current stock quantity (second stock quantity) of the specific product into the user terminal 100. The user terminal 100 transmits the second stock quantity thus entered to the management server 300. In this way, the management server 300 will still be able to accurately manage the stock quantity of the specific product.

Moreover, when an affirmative determination is made in the predetermined determination processing in the check processing, the management server 300 may transmit the instruction information and the request information to each of the user terminal 100 and the sensor 200. Thus, both the transmission of the current stock quantity of the specific product by the sensor 200 and the notification of the current stock quantity of the specific product by the user 10 are performed. As a result, the management server 300 will be able to more accurately grasp the stock quantity of the specific product than in the case where the instruction information is transmitted to either one of the user terminal 100 and the sensor 200.

Further, the instruction information may be transmitted to a sensor (hereinafter, may be referred to as “another sensor”) other than the sensor 200 that senses the specific product to detect a detection value related to the stock quantity of the specific product. In this case, upon receiving the instruction information, another sensor checks the current stock quantity of the specific product. Then, another sensor transmits the current stock quantity of the specific product thus checked to the management server 300. In this way, it is still possible to detect the current stock quantity of the specific product. In addition, even in cases where an incorrect weight of the specific product is detected again by the sensor 200, the management server 300 can obtain a detection value related to the correct stock quantity of the specific product by another sensor. As a result, the management server 300 will be able to accurately grasp the stock quantity of the specific product.

### Second Embodiment

In a second embodiment, the management server 300 estimates the stock quantity of the specific product based on an order history of the specific product of the user 10. Then, the management server 300 manages the stock quantity of the specific product based on the estimated stock quantity of the specific product. That is, the management server 300 uses the estimated stock quantity of the specific product as an estimated value of the stock quantity of the specific product, and manages the stock quantity of the specific product based on the estimated value. Hereinafter, only differences from the first embodiment will be described.

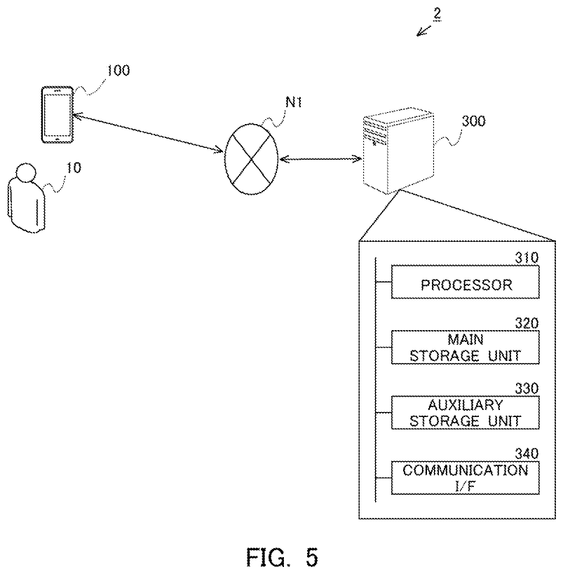

A management system 2 in the present embodiment will be described based on FIG. 5. FIG. 5 is a view illustrating a schematic configuration of the management system 2 in the present embodiment. The management system 2 is configured to include the user terminal 100 and the management server 300.

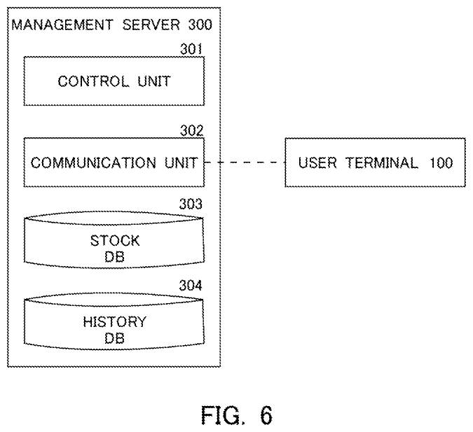

FIG. 6 is a block diagram schematically illustrating an example of the functional configuration of the management server 300 in the present embodiment. The management server 300 in the present embodiment is configured to include the control unit 301, the communication unit 302, the stock DB 303, and a history database 304 (history DB 304). The history DB 304 is a database for storing history information related to the order history of the specific product of the user 10. The history DB 304 can be realized by the auxiliary storage unit 330 in the management server 300.

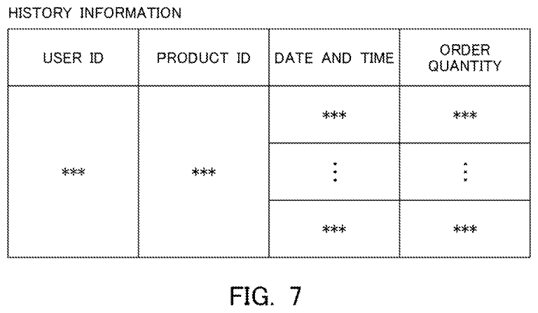

FIG. 7 is a diagram illustrating an example of a table configuration of the history information stored in the history DB 304. As illustrated in FIG. 7, the history information includes a user ID field, a product ID field, a date and time field, and an order quantity field. A user ID and a product ID are entered in the user ID field and the product ID field, respectively. In the product ID field, a product ID corresponding to the specific product is entered. In the date and time field, a date and time when the specific product corresponding to the product ID entered in the product ID field was ordered is entered. Specifically, the control unit 301 enters the date and time when the user terminal 100 transmitted order information into the date and time field. When the user 10 orders the specific product a plurality of times, a plurality of dates and times are entered into the date and time field. In the order quantity field, an order quantity of the specific product when the user 10 ordered the specific product at the date and time entered in the date and time field is entered.

Based on the history information stored in the history DB 304, the control unit 301 estimates the stock quantity of the specific product held by the user 10 based on the history information stored in the history DB 304. Specifically, based on the history information, the control unit 301 obtains the date and time when the user 10 ordered the specific product in the past and the order quantity of the specific product at that time. Then, a daily consumption quantity of the specific product is calculated based on the date and time when the user 10 ordered the specific product in the past and the order quantity of the specific product at that time. In addition, the control unit 301 calculates, based on the history information, the number of days elapsed from the date and time when the user 10 last ordered the specific product. The control unit 301 calculates the consumption quantity of the specific product after the user 10 last ordered the specific product, based on the consumption quantity of the specific product per day and the number of days elapsed. The control unit 301 estimates the stock quantity of the specific product as the first stock quantity, based on the order quantity of the specific product at the time when the user 10 last ordered the specific product and the consumption quantity of the specific product thus calculated. The control unit 301 generates stock information based on the estimated first stock quantity, and stores the stock information in the stock DB 303.

Here, note that a method of estimating the stock quantity of the specific product held by the user 10 based on the history information is not limited to the above-described method. A known method can be adopted as the method of estimating the stock quantity of the specific product held by the user 10 based on the history information.

(Estimation Processing)

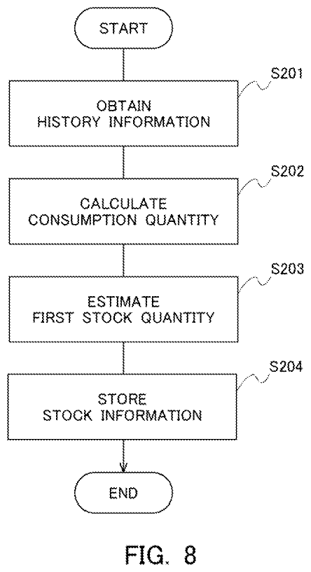

Next, in the management system 1 according to the present embodiment, estimation processing to be performed by the control unit 301 in the management server 300 will be described based on FIG. 8. FIG. 8 is a flowchart of estimation processing. The estimation processing is processing for estimating the stock quantity of the specific product. The estimation processing is repeatedly performed at regular intervals.

In the estimation processing, first in S201, history information is obtained from the history DB 304. Then, in S202, the consumption quantity of the specific product is calculated based on the history information thus obtained. Subsequently, in S203, the first stock quantity is estimated based on the order quantity of the specific product at the time when the user 10 last ordered the specific product and the consumption quantity of the specific product. Thereafter, in S204, stock information is generated based on the estimated first stock quantity and stored in the stock DB 303. Then, the estimation processing is ended.

As described above, the management server 300 estimates, based on the history information, the stock quantity of the specific product held by the user 10 as the first stock quantity. Then, the management server 300 manages the stock quantity of the specific product based on the first stock quantity thus estimated. In this case, the first stock quantity may differ from the second stock quantity due to a change in the consumption quantity of the specific product or the like. Therefore, when receiving the order information from the user terminal 100, the management server 300 performs check processing. When an affirmative determination is made in the predetermined determination processing in the check processing, the management server 300 transmits request information to the user terminal 100. This enables the management server 300 to obtain the current stock quantity of the specific product notified by the user 10. In this way, the management server 300 is restrained or prevented from managing the stock quantity of the specific product based on the incorrect stock quantity of the specific product. As a result, it will be possible to accurately manage the stock quantity of the specific product.

(Modification)

In the present embodiment, the management system 2 does not include the sensor 200. However, similarly to the management system 1, the management system 2 may include the sensor 200. In this case, when an affirmative determination is made in the predetermined determination processing in the check processing, the management server 300 transmits instruction information to the sensor 200. As a result, the management server 300 can obtain the current stock quantity of the specific product checked by the sensor 200. In this way, it is still possible to accurately manage the stock quantity of the specific product.

### Other Embodiments

The above-described embodiments and modifications are merely examples, but the present disclosure can be implemented with appropriate modifications without departing from the spirit thereof. In addition, the processing and/or devices, units, etc. described in the present disclosure can be freely combined and implemented as long as no technical contradiction occurs.

The processing described as being performed by one device or unit may be shared and performed by a plurality of devices or units. Alternatively, the processing described as being performed by different devices or units may be performed by one device or unit. In a computer system, a hardware configuration (server configuration) for realizing each function thereof can be changed in a flexible manner.

The present disclosure can also be realized by supplying to a computer a computer program in which the functions described in the above-described embodiments or their modifications are implemented, and reading out and executing the program by one or more processors included in the computer. Such a computer program may be provided to the computer by a non-transitory computer readable storage medium that can be connected to a system bus of the computer, or may be provided to the computer via a network. The non-transitory computer readable storage medium includes any type of medium suitable for storing electronic commands or instructions, such as, for example, any type of disk such as a magnetic disk (e.g., a floppy (registered trademark) disk, a hard disk drive (HDD), or the like) or an optical disk (e.g., a CD-ROM, a DVD disk, a Blu-ray disk, or the like), a read-only memory (ROM), a random-access memory (RAM), an EPROM, an EEPROM, a magnetic card, a flash memory, an optical card, or the like.

What is claimed is:

1. An information processing apparatus including a controller comprising at least one processor configured to perform:
obtaining an estimated value of a stock quantity of a specific product at a timing when an order for the specific product held by a user is received from the user; and
executing processing for checking a current stock quantity of the specific product, when the estimated value thus obtained is equal to or greater than a predetermined threshold value at which the user is assumed to place an order for the specific product.

2. The information processing apparatus according to claim 1, wherein the estimated value is a value that is based on a detection value related to a stock quantity of the specific product detected by a sensor for sensing the specific product.

3. The information processing apparatus according to claim 2, wherein the sensor is a weight sensor for detecting a weight of the specific product.

4. The information processing apparatus according to claim 2, wherein the sensor is a sensor for reading a non-contact IC chip in the specific product.

5. The information processing apparatus according to claim 2, wherein the processing for checking the current stock quantity of the specific product is to instruct the sensor or a sensor other than the sensor for detecting a detection value related to the stock quantity of the specific product to check the current stock quantity of the specific product.

6. The information processing apparatus according to claim 1, wherein the controller further performs an estimation of the estimated value based on an order history of the specific product of the user.

7. The information processing apparatus according to claim 1, wherein the processing for checking the current stock quantity of the specific product is to request the user to notify the current stock quantity of the specific product.

8. An information processing method to be performed by a computer, comprising:
obtaining an estimated value of a stock quantity of a specific product at a timing when an order for the specific product held by a user is received from the user; and
executing processing for checking a current stock quantity of the specific product, when the estimated value thus obtained is equal to or greater than a predetermined threshold value at which the user is assumed to place an order for the specific product.

9. The information processing method according to claim 8, wherein the estimated value is a value that is based on a detection value related to a stock quantity of the specific product detected by a sensor for sensing the specific product.

10. The information processing method according to claim 9, wherein the sensor is a weight sensor for detecting a weight of the specific product.

11. The information processing method according to claim 9, wherein the sensor is a sensor for reading a non-contact IC chip in the specific product.

12. The information processing method according to claim 9, wherein the processing for checking the current stock quantity of the specific product is to instruct the sensor or a sensor other than the sensor for detecting a detection value related to the stock quantity of the specific product to check the current stock quantity of the specific product.

13. The information processing method according to claim 8, further comprising estimating the estimated value based on an order history of the specific product of the user.

14. The information processing method according to claim 8, wherein the processing for checking the current stock quantity of the specific product is to request the user to notify the current stock quantity of the specific product.

15. A non-transitory storage medium storing a program for causing a computer to perform an information processing method that comprises:
obtaining an estimated value of a stock quantity of a specific product at a timing when an order for the specific product held by a user is received from the user; and
executing processing for checking a current stock quantity of the specific product, when the estimated value thus obtained is equal to or greater than a predetermined threshold value at which the user is assumed to place an order for the specific product.

16. The non-transitory storage medium according to claim 15, wherein the estimated value is a value that is based on a detection value related to a stock quantity of the specific product detected by a sensor for sensing the specific product.

17. The non-transitory storage medium according to claim 16, wherein the sensor is a weight sensor for detecting a weight of the specific product.

18. The non-transitory storage medium according to claim 16, wherein the processing for checking the current stock quantity of the specific product is to instruct the sensor or a sensor other than the sensor for detecting a detection value related to the stock quantity of the specific product to check the current stock quantity of the specific product.

19. The non-transitory storage medium according to claim 15, wherein the information processing method further comprises estimating the estimated value based on an order history of the specific product of the user.

20. The non-transitory storage medium according to claim 15, wherein the processing for checking the current stock quantity of the specific product is to request the user to notify the current stock quantity of the specific product.
